(19) United States
(12) Patent Application Publication
(10) Pub. No.: US 2009/0140672 A1
(43) Pub. Date: Jun. 4, 2009

(54) Interrupted Particle Source

(76) Inventors: Kenneth Gall, Harvard, MA (US); Gerrit Townsend Zwart, Durham, NH (US)

Correspondence Address: FISH & RICHARDSON PC, P.O. BOX 1022, MINNEAPOLIS, MN, 55440-1022, US

(21) Appl. No.: 11/948,662

(22) Filed: Nov. 30, 2007

(51) Int. Cl. H05H 13/02

(52) U.S. Cl. 315/502; 315/500; 315/501

(57) ABSTRACT

A synchrocyclotron includes magnetic structures to provide a magnetic field to a cavity, a particle source to provide a plasma column to the cavity, where the particle source has a housing to hold the plasma column, and where the housing is interrupted at an acceleration region to expose the plasma column, and a voltage source to provide a radio frequency (RF) voltage to the cavity to accelerate particles from the plasma column at the acceleration region.

### TECHNICAL FIELD

This patent application describes a particle accelerator having a particle source that is interrupted at an acceleration region.

### BACKGROUND

In order to accelerate charged particles to high energies, many types of particle accelerators have been developed. One type of particle accelerator is a cyclotron. A cyclotron accelerates charged particles in an axial magnetic field by applying an alternating voltage to one or more dees in a vacuum chamber. The name dee is descriptive of the shape of the electrodes in early cyclotrons, although they may not resemble the letter D in some cyclotrons. The spiral path produced by the accelerating particles is perpendicular to the magnetic field. As the particles spiral out, an accelerating electric field is applied at the gap between the dees. The radio frequency (RF) voltage creates an alternating electric field across the gap between the dees. The RF voltage, and thus the field, is synchronized to the orbital period of the charged particles in the magnetic field so that the particles are accelerated by the radio frequency waveform as they repeatedly cross the gap. The energy of the particles increases to an energy level greatly in excess of the peak voltage of the applied RF voltage. As the charged particles accelerate, their masses grow due to relativistic effects. Consequently, the acceleration of the particles varies the phase match at the gap.

Two types of cyclotrons presently employed, an isochronous cyclotron and a synchrocyclotron, overcome the challenge of increase in relativistic mass of the accelerated particles in different ways. The isochronous cyclotron uses a constant frequency of the voltage with a magnetic field that increases with radius to maintain proper acceleration. The synchrocyclotron uses a decreasing magnetic field with increasing radius to provide axial focusing and varies the frequency of the accelerating voltage to match the mass increase caused by the relativistic velocity of the charged particles.

### SUMMARY

In general, this patent application describes a synchrocyclotron comprising magnetic structures to provide a magnetic field to a cavity, and a particle source to provide a plasma column to the cavity. The particle source has a housing to hold the plasma column. The housing is interrupted at an acceleration region to expose the plasma column. A voltage source is configured to provide a radio frequency (RF) voltage to the cavity to accelerate particles from the plasma column at the acceleration region. The synchrocyclotron described above may include one or more of the following features, either alone or in combination.

The magnetic field may be above 2 Tesla (T), and the particles may accelerate from the plasma column outwardly in spirals with radii that progressively increase. The housing may comprise two portions that are completely separated at the acceleration region to expose the plasma column. The voltage source may comprise a first dee that is electrically connected to an alternating voltage and a second dee that is electrically connected to ground. At least part of the particle source may pass through the second dee. The synchrocyclotron may comprise a stop in the acceleration region. The stop may be for blocking acceleration of at least some of the particles from the plasma column. The stop may be substantially orthogonal to the acceleration region and may be configured to block certain phases of particles from the plasma column.

The synchrocyclotron may comprise cathodes for use in generating the plasma column. The cathodes may be operable to pulse a voltage to ionize gas to generate the plasma column. The cathodes may be configured to pulse at voltages between about 1 kV to about 4 kV. The cathodes need not be heated by an external heat source. The synchrocyclotron may comprise a circuit to couple voltage from the RF voltage to the at least one of the cathodes. The circuit may comprise a capacitive circuit.

The magnetic structures may comprise magnetic yokes. The voltage source may comprise a first dee that is electrically connected to an alternating voltage and a second dee that is electrically connected to ground. The first dee and the second dee may form a tunable resonant circuit. The cavity to which the magnetic field is applied may comprise a resonant cavity containing the tunable resonant circuit.

In general, this patent application also describes a particle accelerator comprising a tube containing a gas, a first cathode adjacent to a first end of the tube, and a second cathode adjacent to a second end of the tube. The first and second cathodes are for applying voltage to the tube to form a plasma column from the gas. Particles are available to be drawn from the plasma column for acceleration. A circuit is configured to couple energy from an external radio frequency (RF) field to at least one of the cathodes. The particle accelerator described above may include one or more of the following features, either alone or in combination.

The tube may be interrupted at an acceleration region at which the particles are drawn from the plasma column. The first cathode and the second cathode need not be heated by an external source. The first cathode may be on a different side of the acceleration region than the second cathode.

The particle accelerator may comprise a voltage source to provide the RF field. The RF field may be for accelerating the particles from the plasma column at the acceleration region. The energy may comprise a portion of the RF field provided by the voltage source. The circuit may comprise a capacitor to couple energy from the external field to at least one of the first cathode and the second cathode.

The tube may comprise a first portion and a second portion that are completely separated at a point of interruption at the acceleration region. The particle accelerator may comprise a stop at the acceleration region. The stop may be used to block at least one phase of the particles from further acceleration.

The particle accelerator may comprise a voltage source to provide the RF field to the plasma column. The RF field may be for accelerating the particles from the plasma column at the acceleration region. The RF field may comprise a voltage that is less than 15 kV. Magnetic yokes may be used to provide a magnetic field that crosses the acceleration region. The magnetic field may be greater than about 2 Tesla (T).

In general, this patent application also describes a particle accelerator comprising a Penning ion gauge (PIG) source comprising a first tube portion and a second tube portion that are at least partially separated at an acceleration region. The first tube portion and the second tube portion are for holding a plasma column that extends across the acceleration region. A voltage source is used to provide a voltage at the acceleration region. The voltage is for accelerating particles out of the plasma column at the acceleration region. The particle accelerator described above may include one or more of the following features, either alone or in combination.

The first tube portion and the second tube portion may be completely separated from each other. Alternatively, only one or more portions of the first tube portion may be separated from corresponding portions of the second tube portion. In this latter configuration, the PIG source may comprise a physical connection between a part of the first tube portion and the second tube portion. The physical connection may enable particles accelerating out of the plasma column to complete a first turn upon escaping from the plasma column without running into the physical connection.

The PIG source may pass through a first dee that is electrically connected to ground. A second dee that is electrically connected to an alternating voltage source may provide the voltage at the acceleration region.

The particle accelerator may comprise a structure that substantially encloses the PIG source. The particle accelerator may comprise magnetic yokes that define a cavity containing the acceleration region. The magnetic yokes may be for generating a magnetic field across the acceleration region. The magnetic field may be at least 2 Tesla (T). For example, the magnetic field may be at least 10.5 T. The voltage may comprise a radio frequency (RF) voltage that is less than 15 kV.

The particle accelerator may comprise one or more electrodes for use in accelerating the particles out of the particle accelerator. At least one cathode may be used in generating the plasma column. The at least one cathode used in generating the plasma column may comprise a cold cathode (e.g., one that is not heated by an external source). A capacitive circuit may couple at least some of the voltage to the cold cathode. The cold cathode may be configured to pulse voltage to generate the plasma column from gas in the first tube portion and the second tube portion.

Any of the foregoing features may be combined to form implementations not specifically described herein.

The details of one or more examples are set forth in the accompanying drawings and the description below. Further features, aspects, and advantages will become apparent from the description, the drawings, and the claims.

### DESCRIPTION OF THE DRAWINGS

FIG. 1A is a cross-sectional view of a synchrocyclotron.

FIG. 1B is a side cross-sectional view of the synchrocyclotron shown in FIG. 1A.

FIG. 2 is an illustration of an idealized waveform that can be used for accelerating charged particles in the synchrocyclotron of FIGS. 1A and 1B.

FIG. 3A is a side view of a particle source, such as a Penning ion gauge source.

FIG. 3B is a close-up side view of a portion of the particle source of FIG. 3A passing through a dummy dee and adjacent to an RF dee.

FIG. 4 is a side view of the particle source of FIG. 3 showing spiral acceleration of a particle from a plasma column generated by the particle source.

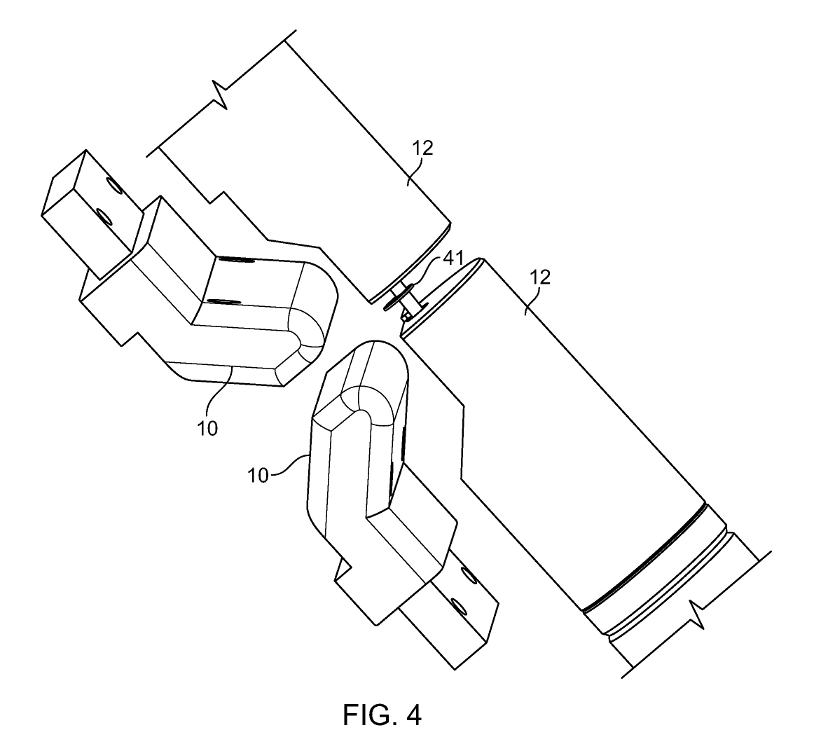

FIG. 5 is a perspective view of the particle source of FIG. 4

FIG. 6 is a perspective view of the particle source of FIG. 4 containing a stop for blocking one or more phases of particles.

FIG. 7 is a perspective view of an alternative embodiment, in which a substantial portion of the ion source is removed.

### DETAILED DESCRIPTION

A synchrocyclotron-based system is described herein. However, the circuits and methods described herein may used with any type of cyclotron or particle accelerator.

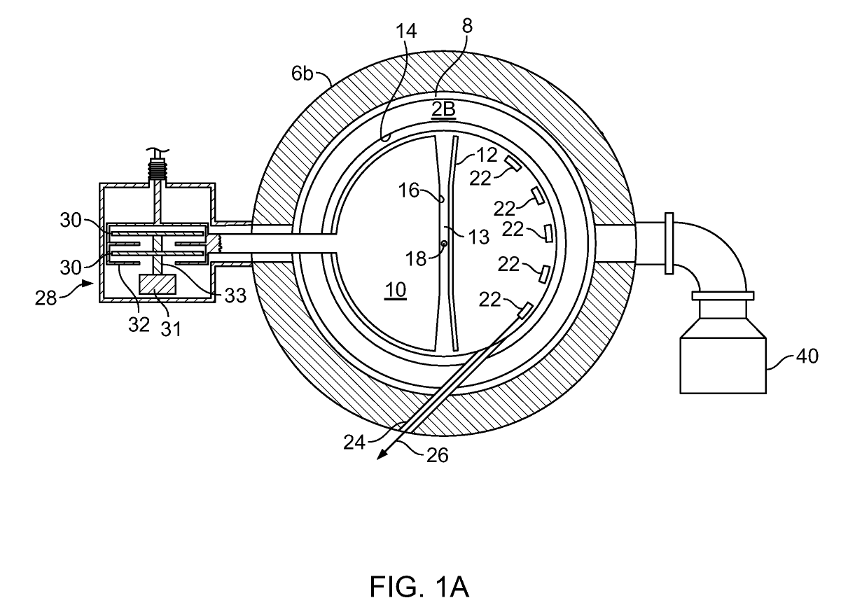

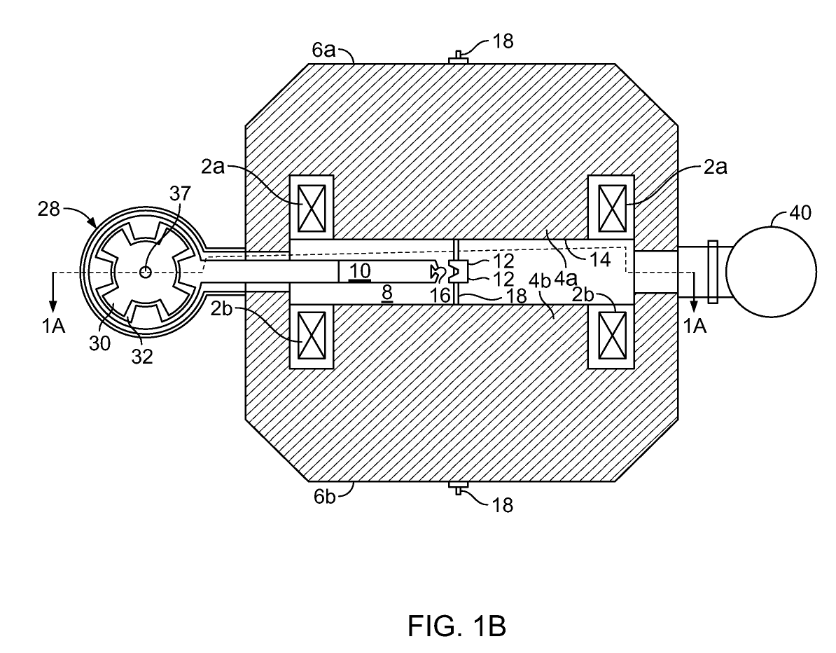

Referring to FIGS. 1A and 1B, a synchrocyclotron 1 includes electrical coils 2a and 2b around two spaced apart ferro-magnetic poles 4a and 4b, which are configured to generate a magnetic field. Magnetic poles 4a and 4b are defined by two opposing portions of yokes 6a and 6b (shown in cross-section). The space between poles 4a and 4b defines vacuum chamber 8 or a separate vacuum chamber can be installed between poles 4a and 4b. The magnetic field strength is generally a function of distance from the center of vacuum chamber 8 and is determined largely by the choice of geometry of coils 2a and 2b and the shape and material of magnetic poles 4a and 4b.

The accelerating electrodes are defined as dee 10 and dee 12, having gap 13 between them. Dee 10 is connected to an alternating voltage potential whose frequency is changed from high to low during an accelerating cycle in order to account for the increasing relativistic mass of a charged particle and radially decreasing magnetic field (measured from the center of vacuum chamber 8) produced by coils 2a and 2b and pole portions 4a and 4b. Accordingly, dee 10 is referred to as the radio frequency (RF) dee. The idealized profile of the alternating voltage in dees 10 and 12 is show in FIG, 2 and will be discussed in detail below. In this example, RF dee 10 is a half-cylinder structure, which is hollow inside. Dee 12, also referred to as the “dummy dee”, does not need to be a hollow cylindrical structure, since it is grounded at the vacuum chamber walls 14. Dee 12, as shown in FIGS. 1A and 1B, includes a strip of metal, e.g., copper, having a slot shaped to match a substantially similar slot in RF dee 10. Dee 12 can be shaped to form a mirror image of surface 16 of RF dee 10.

Ion source 18 is located at about the center of vacuum chamber 8, and is configured to provide particles (e.g., protons) at a center of the synchrocyclotron for acceleration, as described below. Extraction electrodes 22 direct the charged particles from an acceleration region into extraction channel 24, thereby forming beam 26 of the charged particles. Here, ion source 18 is inserted axially into the acceleration region.

Dees 10 and 12 and other pieces of hardware included in a synchrocyclotron define a tunable resonant circuit under an oscillating voltage input that creates an oscillating electric field across gap 13. The result is a resonant cavity in vacuum chamber 8. This resonant frequency of the resonant cavity can be tuned to keep its Q-factor high by synchronizing the frequency being swept. In one example, the resonant frequency of the resonant cavity moves, or “sweeps”, within a range of about 30 Megahertz (MHz) and about 135 MHz (VHF range) over time, e.g., over about 1 millisecond (ms). In another example, the resonant frequency of the resonant cavity moves, or sweeps, between about 95 MHz and about 135 MHz in about 1 ms. Resonance of the cavity may be controlled in the manner described in U.S. patent application Ser. No. 11/948,359, entitled “Matching A Resonant Frequency Of A Resonant Cavity To A Frequency Of An Input Voltage” (Attorney Docket No. 17970-011001), the contents of which are incorporated herein by reference as if set forth in full.

The Q-factor is a measure of the “quality” of a resonant system in its response to frequencies close to the resonant frequency. In this example, the Q-factor is defined as

Q=1/R×√(L/C),

where R is the active resistance of the resonant circuit, L is the inductance, and C is the capacitance of the resonant circuit.

The tuning mechanism can be, e.g., a variable inductance coil or a variable capacitance. A variable capacitance device can be a vibrating reed or a rotating capacitor. In the example shown in FIGS. 1A and 1B, the tuning mechanism includes rotating capacitor 28. Rotating capacitor 28 includes rotating blades 30 that are driven by a motor 31. During each cycle of motor 31, as blades 30 mesh with blades 32, the capacitance of the resonant circuit that includes dees 10 and 12 and rotating capacitor 28 increases and the resonant frequency decreases. The process reverses as the blades unmesh. Thus, the resonant frequency is changed by changing the capacitance of the resonant circuit. This serves the purpose of reducing, by a large factor, the power required to generate the high voltage applied at the dee/dummy dee gap at the frequency necessary to accelerate the particle beam. The shape of blades 30 and 32 can be machined so as to create the required dependence of resonant frequency on time.

The blade rotation can be synchronized with RF frequency generation so the frequency of the resonant circuit defined by the synchrocyclotron is kept close to the frequency of the alternating voltage potential applied to the resonant cavity. This promotes efficient transformation of applied RF power to RF voltage on the RF dee.

A vacuum pumping system 40 maintains vacuum chamber 8 at a very low pressure so as not to scatter the accelerating beam (or to provide relatively little scattering) and to substantially prevent electrical discharges from the RF dee.

To achieve substantially uniform acceleration in the synchrocyclotron, the frequency and the amplitude of the electric field across the dee gap is varied to account for the relativistic mass increase and radial variation of magnetic field as well as to maintain focus of the beam of particles. The radial variation of the magnetic field is measured as a distance from the center of an outwardly spiraling trajectory of a charged particle.

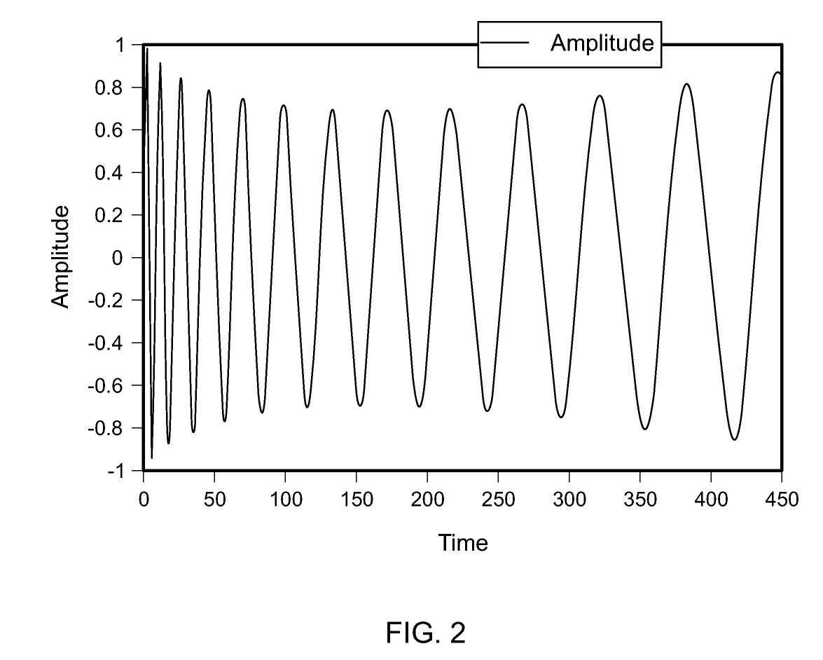

FIG. 2 is an illustration of an idealized waveform that may be required for accelerating charged particles in a synchrocyclotron. It shows only a few cycles of the waveform and does not necessarily represent the ideal frequency and amplitude modulation profiles. FIG. 2 illustrates the time varying amplitude and frequency properties of the waveform used in the synchrocyclotron. The frequency changes from high to low as the relativistic mass of the particle increases while the particle speed approaches a significant fraction of the speed of light.

Ion source 18 is deployed near to the magnetic center of synchrocyclotron 1 so that particles are present at the synchrocyclotron mid-plane, where they can be acted upon by the RF field (voltage). The ion source may have a Penning ion gauge (PIG) geometry. In the PIG geometry, two high voltage cathodes are placed about opposite each other. For example, one cathode may be on one side of the acceleration region and one cathode may be on the other side of the acceleration region and in line with the magnetic field lines. The dummy dee housings 12 of the source assembly may be at ground potential. The anode includes a tube extending toward the acceleration region. When a relatively small amount of a gas (e.g., hydrogen/H₂) occupies a region in the tube between the cathodes, a plasma column may be formed from the gas by applying a voltage to the cathodes. The applied voltage causes electrons to stream along the magnetic field lines, essentially parallel to the tube walls, and to ionize gas molecules that are concentrated inside the tube, thereby creating the plasma column.

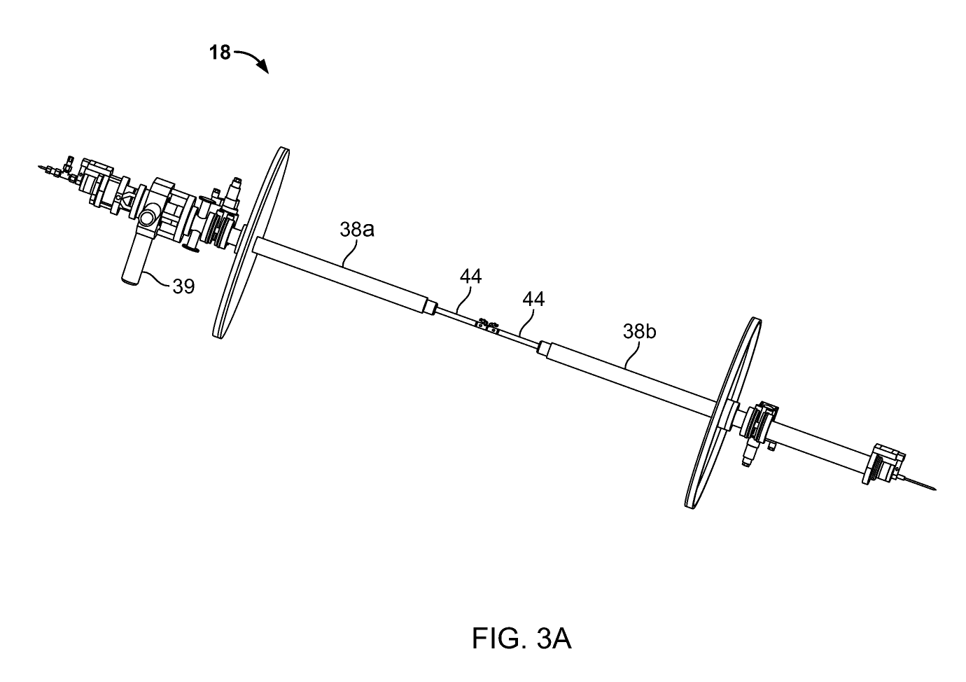

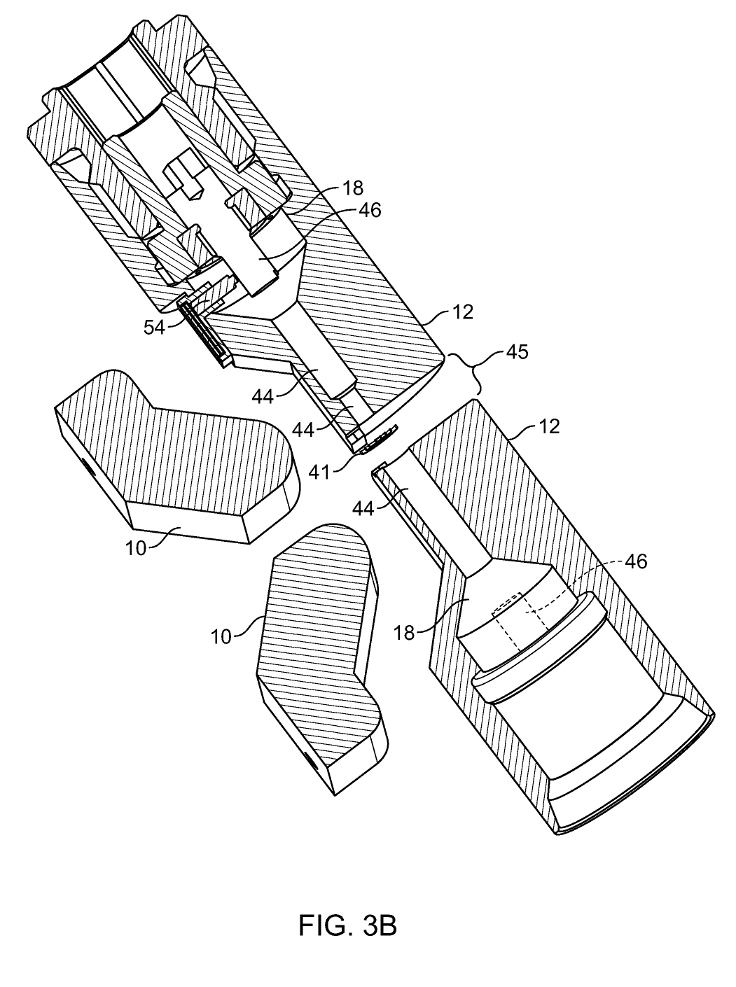

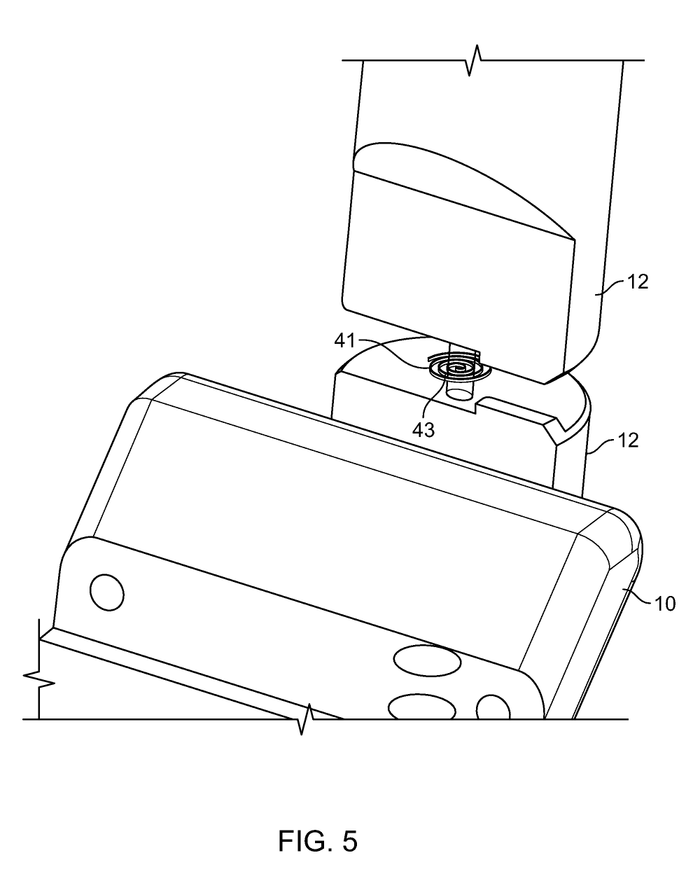

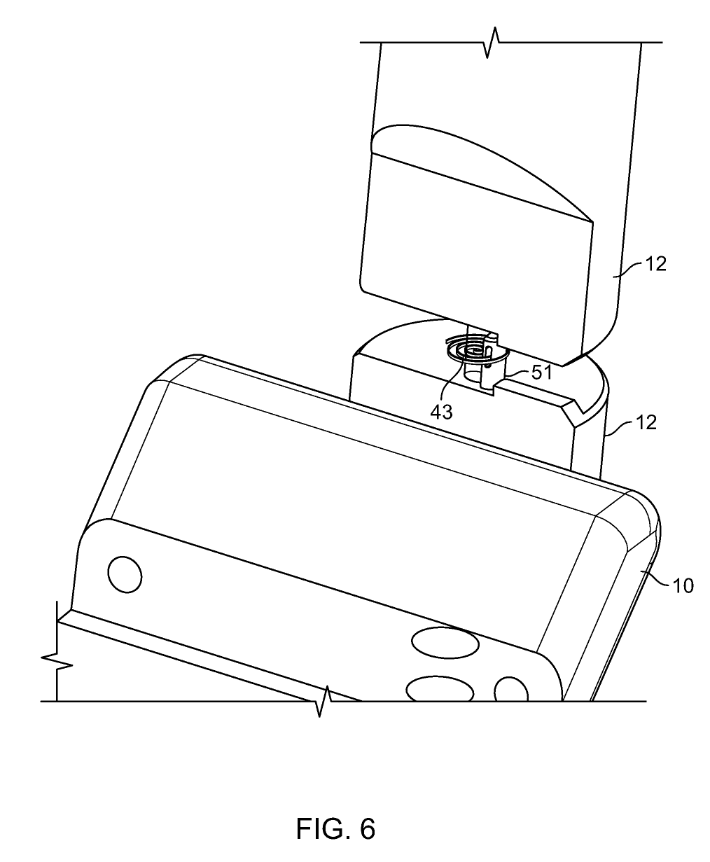

A PIG geometry ion source 18, for use in synchrocyclotron 1, is shown in FIGS. 3A and 3B. Referring to FIG. 3A, ion source 18 includes an emitter side 38a containing a gas feed 39 for receiving gas, and a reflector side 38b. A housing, or tube, 44 holds the gas, as described below. FIG. 3B shows ion source 18 passing through dummy dee 12 and adjacent to RF dee 10. In operation, the magnetic field between RF dee 10 and dummy dee 12 causes particles (e.g., protons) to accelerate outwardly. The acceleration is spiral about the plasma column, with the particle-to-plasma-column radius progressively increasing. The spiral acceleration, labeled 43, is depicted in FIGS. 5 and 6. The radii of curvature of the spirals depend on a particle's mass, energy imparted to the particle by the RF field, and a strength of the magnetic field.

When the magnetic field is high, it can become difficult to impart enough energy to a particle so that it has a large enough radius of curvature to clear the physical housing of the ion source on its initial turn(s) during acceleration. The magnetic field is relatively high in the region of the ion source, e.g., on the order of 2 Tesla (T) or more (e.g., 8 T, 8.8 T, 8.9T, 9 T, 10.5 T, or more). As a result of this relatively high magnetic field, the initial particle-to-ion-source radius is relatively small for low energy particles, where low energy particles include particles that are first drawn from the plasma column. For example, such a radius may be on the order of 1 mm. Because the radii are so small, at least initially, some particles may come into contact with the ion source's housing area, thereby preventing further outward acceleration of such particles. Accordingly, the housing of ion source 18 is interrupted, or separated to form two parts, as shown in FIG. 3B. That is, a portion of the ion source's housing is removed at the acceleration region 41, e.g., at about the point where the particles are to be drawn from the ion source. This interruption is labeled 45 in FIG. 3B. The housing may also be removed for distances above, and below, the acceleration region. All or part of dummy dee 12 at the acceleration region may, or may not, also be removed.

In the example of FIGS. 3A and 3B, the housing 44 includes a tube, which holds a plasma column containing particles to be accelerated. The tube may have different diameters at different points, as shown. The tube may reside within dummy dee 12, although this is not necessary. A portion of the tube in about a median plane of the synchrocyclotron is completely removed, resulting in a housing comprised of two separate portions with an interruption 45 between the portions. In this example, the interruption is about 1 millimeter (mm) to 3 mm (i.e., about 1 mm to 3 mm of the tube is removed). The amount of the tube that is removed may be significant enough to permit particle acceleration from the plasma column, but small enough to hinder significant dissipation of the plasma column in the interrupted portion.

By removing the physical structure, here the tube, at the particle acceleration region, particles can make initial turn(s) at relatively small radii—e.g., in the presence of relatively high magnetic fields—without coming in to contact with physical structures that impede further acceleration. The initial turn(s) may even cross back through the plasma column, depending upon the strength of the magnetic and RF fields.

The tube may have a relatively small interior diameter, e.g., about 2 mm. This leads to a plasma column that is also relatively narrow and, therefore, provides a relatively small set of original radial positions at which the particles can start accelerating. The tube is also sufficiently far from cathodes 46 used to produce the plasma column—in this example, about 10 mm from each cathode. These two features, combined, reduce the amount of hydrogen (H₂) gas flow into the synchrocyclotron to less than 1 standard cubic centimeter per minute (SCCM), thereby enabling the synchrocyclotron to operate with relatively small vacuum conductance apertures into the synchrocyclotron RF/beam cavity and relatively small capacity vacuum pump systems, e.g., about 500 liters-per-second.

Interruption of the tube also supports enhanced penetration of the RF field into the plasma column. That is, since there is no physical structure present at the interruption, the RF field can easily reach the plasma column. Furthermore, the interruption in the tube allows particles to be accelerated from the plasma column using different RF fields. For example, lower RF fields may be used to accelerate the particles. This can reduce the power requirements of systems used to generate the RF field. In one example, a 20 kilowatt (kW) RF system generates an RF field of 15 kilovolts (kV) to accelerate particles from the plasma column. The use of lower RF fields reduces RF system cooling requirements and RF voltage standoff requirements.

In the synchrocyclotron described herein, a particle beam is extracted using a resonant extraction system. That is, the amplitude of radial oscillations of the beam are increased by a magnetic perturbation inside the accelerator, which is in resonance with these oscillations. When a resonant extraction system is used, extraction efficiency is improved by limiting the phase space extent of the internal beam. With attention to the design of the magnetic and RF field generating structures, the phase space extent of the beam at extraction is determined by the phase space extent at the beginning of acceleration (e.g., at emergence from the ion source). As a result, relatively little beam may be lost at the entrance to the extraction channel and background radiation from the accelerator can be reduced.

A physical structure, or stop, may be provided to control the phase of the particles that are allowed to escape from the central region of the synchrocyclotron. An example of such a stop 51 is shown in FIG. 6. Stop 51 acts as a obstacle that blocks particles having certain phases. That is, particles that hit the stop are prevented from accelerating further, whereas particles that pass the stop continue their acceleration out of the synchrocyclotron. A stop may be near the plasma column, as shown in FIG. 6, in order to select phases during the initial turn(s) of particles where the particle energy is low, e.g., less than 50 kV. Alternatively, a stop may be located at any other point relative to the plasma column. In the example shown in FIG. 6, a single stop is located on the dummy dee 12. There, however, may be more than one stop (not shown) per dee.

Cathodes 46 may be “cold” cathodes. A cold cathode may be a cathode that is not heated by an external heat source. Also, the cathodes may be pulsed, meaning that they output signal burst(s) periodically rather than continuously. When the cathodes are cold, and are pulsed, the cathodes are less subject to wear and can therefore last relatively long. Furthermore, pulsing the cathodes can eliminate the need to water-cool the cathodes. In one implementation, cathodes 46 pulse at a relatively high voltage, e.g., about 1 kV to about 4 kV, and moderate peak cathode discharge currents of about 50 mA to about 200 mA at a duty cycle between about 0.1% and about 1% or 2% at repetition rates between about 200 Hz to about 1 KHz.

Cold cathodes can sometimes cause timing jitter and ignition delay. That is, lack of sufficient heat in the cathodes can affect the time at which electrons are discharged in response to an applied voltage. For example, when the cathodes are not sufficiently heated, the discharge may occur several microseconds later, or longer, than expected. This can affect formation of the plasma column and, thus, operation of the particle accelerator. To counteract these effects, voltage from the RF field in cavity 8 may be coupled to the cathodes. Cathodes 46 are otherwise encased in a metal, which forms a Faraday shield to substantially shield the cathodes from the RF field. In one implementation, a portion of the RF energy may be coupled to the cathodes from the RF field, e.g., about 100V may be coupled to the cathodes from the RF field. FIG. 3B shows an implementation, in which a capacitive circuit 54, here a capacitor, is charged by the RF field and provides voltage to a cathode 46. An RF choke and DC feed may be used to charge the capacitor. A corresponding arrangement (not shown) may be implemented for the other cathode 46. The coupled RF voltage can reduce the timing jitter and reduce the discharge delay to about 100 nanoseconds (ns) or less in some implementations.

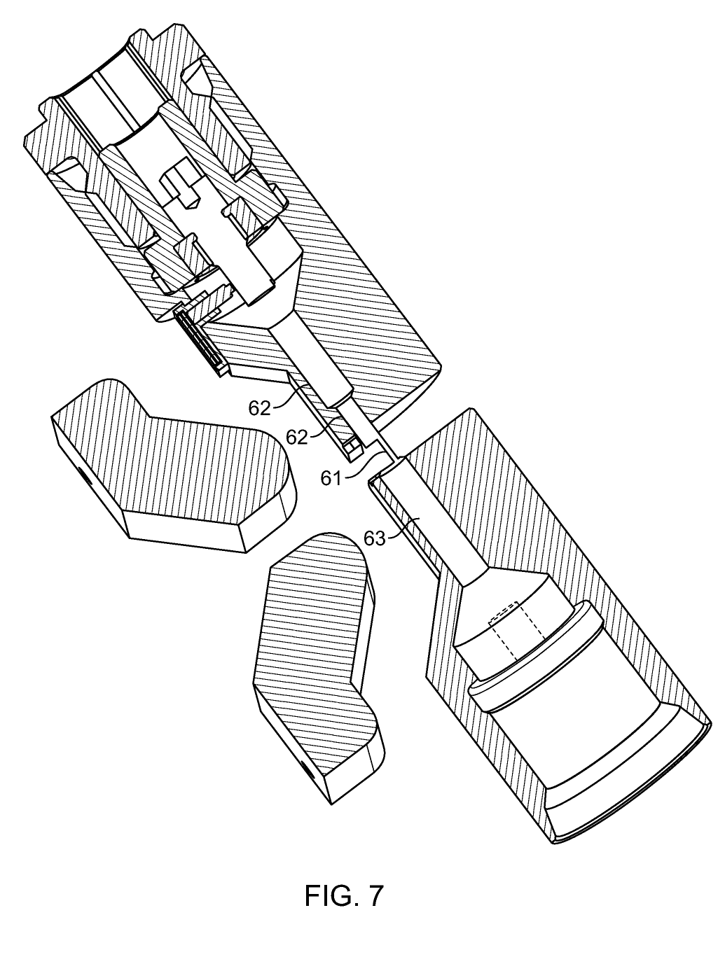

An alternative embodiment is shown in FIG. 7. In this embodiment, a substantial portion, but not all, of the PIG source housing is removed, leaving the plasma beam partly exposed. Thus, portions of the PIG housing are separated from their counterpart portions, but there is not complete separation as was the case above. The portion 61 that remains physically connects the first tube portion 62 and the second tube portion 63 of the PIG source. In this embodiment, enough of the housing is removed to enable particles to perform at least one turn (orbit) without impinging on the portion 61 of the housing that remains. In one example, the first turn radius may be 1 mm, although other turn radii may be implemented. The embodiment shown in FIG. 7 may be combined with any of the other features described herein.

The particle source and accompanying features described herein are not limited to use with a synchrocyclotron, but rather may be used with any type of particle accelerator or cyclotron. Furthermore ion sources other than those having a PIG geometry may be used with any type of particle accelerator, and may have interrupted portions, cold cathodes, stops, and/or any of the other features described herein.

Components of different implementations described herein may be combined to form other embodiments not specifically set forth above. Other implementations not specifically described herein are also within the scope of the following claims.

What is claimed is:

1. A synchrocyclotron comprising:
magnetic structures to provide a magnetic field to a cavity;
a particle source to provide a plasma column to the cavity, the particle source having a housing to hold the plasma column, the housing being interrupted at an acceleration region to expose the plasma column; and
a voltage source to provide a radio frequency (RF) voltage to the cavity to accelerate particles from the plasma column at the acceleration region.

2. The synchrocyclotron of claim 1, wherein the magnetic field is above 2 Tesla (T), and the particles accelerate from the plasma column outwardly in spirals with radii that progressively increase.

3. The synchrocyclotron of claim 1, wherein the housing comprises two portions that are completely separated at the acceleration region to expose the plasma column.

4. The synchrocyclotron of claim 1, wherein the voltage source comprises a first dee that is electrically connected to an alternating voltage and a second dee that is electrically connected to ground; and
wherein at least part of the particle source passes through the second dee.

5. The synchrocyclotron of claim 1, further comprising a stop in the acceleration region, the stop for blocking acceleration of at least some of the particles from the plasma column.

6. The synchrocyclotron of claim 5, wherein the stop is substantially orthogonal to the acceleration region and is configured to block certain phases of particles from the plasma column.

7. The synchrocyclotron of claim 1, further comprising:
cathodes for use in generating the plasma column, the cathodes being operable to pulse a voltage to ionize gas to generate the plasma column;
wherein the cathodes are not heated by an external heat source.

8. The synchrocyclotron of claim 7, wherein the cathodes are configured to pulse at voltages between about 1 kV to about 4 kV.

9. The synchrocyclotron of claim 7, further comprising:
a circuit to couple voltage from the RF voltage to the at least one of the cathodes.

10. The synchrocyclotron of claim 9, wherein the circuit comprises a capacitive circuit.

11. The synchrocyclotron of claim 1, wherein the magnetic structures comprise magnetic yokes, wherein the voltage source comprises a first dee that is electrically connected to an alternating voltage and a second dee that is electrically connected to ground, wherein the first dee and the second dee form a tunable resonant circuit, and wherein the cavity comprises a resonant cavity containing the tunable resonant circuit.

12. A particle accelerator comprising:
a tube containing a gas;
a first cathode adjacent to a first end of the tube; and
a second cathode adjacent to a second end of the tube, the first and second cathodes applying voltage to the tube to form a plasma column from the gas;
wherein particles are available to be drawn from the plasma column for acceleration; and
a circuit to couple energy from an external radio frequency (RF) field to at least one of the cathodes.

13. The particle accelerator of claim 12, wherein the tube is interrupted at an acceleration region at which the particles are drawn from the plasma column; and
wherein the first cathode and the second cathode are not heated by an external source.

14. The particle accelerator of claim 12, wherein the first cathode is on a different side of the acceleration region than the second cathode.

15. The particle accelerator of claim 13, further comprising:
a voltage source to provide the RF field, the RF field for accelerating the particles from the plasma column at the acceleration region.

16. The particle accelerator of claim 15, wherein the energy comprises a portion of the RF field provided by the voltage source.

17. The particle accelerator of claim 13, wherein the circuit comprises a capacitor to couple the energy from the external field to at least one of the first cathode and the second cathode.

18. The particle accelerator of claim 13, wherein the tube comprises a first portion and a second portion that are completely separated at a point of interruption at the acceleration region.

19. The particle accelerator of claim 13, further comprising:
a stop at the acceleration region, the stop to block at least one phase of the particles from further acceleration.

20. The particle accelerator of claim 13, further comprising:
a voltage source to provide the RF field to the plasma column, the RF field for accelerating the particles from the plasma column at the acceleration region, wherein the RF field comprises voltage that is less than 15 kV; and
magnetic yokes to provide a magnetic field that crosses the acceleration region, the magnetic field being greater than about 2 Tesla (T).

21. A particle accelerator comprising:
a Penning ion gauge (PIG) source comprising a first tube portion and a second tube portion that are at least partially separated at an acceleration region, the first tube portion and the second tube portion for holding a plasma column that extends across the acceleration region; and
a voltage source to provide a voltage at the acceleration region, the voltage for accelerating particles out of the plasma column at the acceleration region.

22. The particle accelerator of claim 21, wherein the first tube portion and the second tube portion are completely separated from each other.

23. The particular accelerator of claim 21, wherein portions of the first tube portion are separated from corresponding portions of the second tube portion; and
wherein the PIG source comprises a physical connection between a part of the first tube portion and the second tube portion, the physical connection enabling particles accelerating out of the plasma column to complete a first turn upon escaping from the plasma column without running into the physical connection.

24. The particle accelerator of claim 21, wherein the PIG source passes through a first dee that is electrically connected to ground, and wherein a second dee that is electrically connected to an alternating voltage source provides the voltage at the acceleration region.

25. The particle accelerator of claim 21, further comprising:
magnetic yokes that define a cavity containing the acceleration region, the magnetic yokes for generating a magnetic field across the acceleration region.

26. The particle accelerator of claim 25, wherein the magnetic field is at least 2 Tesla (T).

27. The particle accelerator of claim 26, wherein the magnetic field is at least 10.5 T.

28. The particle accelerator of claim 27, wherein the voltage comprises a radio frequency (RF) voltage that is less than 15 kV.

29. The particle accelerator of claim 21, further comprising one or more electrodes for use in accelerating the particles out of the particle accelerator.

30. The particle accelerator of claim 21, further comprising:
at least one cathode for use in generating the plasma column, the at least one cathode comprising a cold cathode; and
a capacitive circuit to couple at least some of the voltage to the at least one cathode.

31. The particle accelerator of claim 30, wherein the at least one cathode is configured to pulse voltage to generate the plasma column from gas in the first tube portion and the second tube portion.

32. The particle accelerator of claim 31, further comprising a structure that substantially encloses the PIG source.
